(19) United States
(12) Patent Application Publication
(10) Pub. No.: US 2010/0028778 A1
(43) Pub. Date: Feb. 4, 2010

(54) METHOD FOR THE CUTTING OF MECHANICALLY SENSITIVE SHEET STOCK

(75) Inventors: Andreas Schuch, Hamburg (DE); Christian Hying, Rhede (DE); Volker Hennige, Duelmen (DE); Andreas Schormann, Doberschau (DE); Gerhard Hoerpel, Nottuln (DE); Matthias Pascaly, Muenster (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/504,112

(22) Filed: Jul. 16, 2009

(30) Foreign Application Priority Data
Jul. 31, 2008 (DE) 102008040894.8

(51) Int. Cl. H01M 4/58; H01M 2/16; B65H 18/00

(52) U.S. Cl. 429/231.95; 429/247; 429/249; 242/525

(57) ABSTRACT

Sheet stock that is useful as a separator in batteries can be obtained by a method in which (a) the sheet stock is provided, (b) the sheet stock is cut to the required width, and, subsequently, (c) the sheet stock obtained according to step (b) is wound onto a core or tube, and, subsequently, (d) the sheet stock is cut to length on the core or tube along the axis of the core or of the tube. The sheet stock has a carrier and abrasive particles, the abrasive particles being located inside and/or on at least part of the surface of the carrier.

### BACKGROUND OF THE INVENTION

1. Field of the Invention

The present invention relates to a method for the cutting of abrasive sheet stock, that is to say material in which abrasive particles are located inside and/or on the surface of a carrier.

2. Discussion of the Background

For use in lithium-ion batteries, inter alia, separators are employed which consist, for example, of a carrier substance coated with ceramic constituents or containing ceramic constituents. The ceramic constituents of these ceramic separators, as they are known, may consist of aluminium oxide (Al₂O₃) and silicon oxide (SiO₂) and also further metal oxides, such as, for example, BaTiO₃, ZrO₂ or TiO₂. The carrier substances may in this case consist, for example, of polymers, such as polyolefins, polyesters or polyimides. The ceramic constituents may both be introduced into the polymer, in which case the polymer serves as matrix and the oxide as filler, and be applied to a porous polymer carrier in the form of an impregnation, print or infiltration.

Ceramic or semi-ceramic (hybrid) separators or ceramic membranes which can be used as separators are sufficiently known, for example, from WO 99/15262. The production of separators or membranes which are suitable as separators may also be gathered from this publication. Preferably, however, electrically conductive carriers, such as, for example, metal fabrics, are not employed as porous carriers for the separators mentioned, since, when such carriers are used, internal short-circuits may occur if the ceramic coating of the carrier is incomplete. The said separators therefore preferably have carriers consisting of materials which are not electrically conductive.

Hybrid separators have recently been developed which have ceramics and polymers. In DE 102 08 277, separators were produced, based on polymeric substrate materials, such as, for example, polymer bonded webs, which have a porous electrically insulating ceramic coating.

Such ceramic separators are conventionally cut into the desired shape by means of customary commercially available cutting implements, such as circular knives, shears, lever shears, etc., with blades consisting of conventional or else hardened knife steel. The disadvantage in this case is that, sometimes, an enormous loss of material due to abrasion is observed when cutting is being carried out. The abrasion, in turn, often occurs in the form of harmful and at least disruptive dust.

Ceramic separators which, for example, take the form of roll stock are cut, for use in lithium-ion batteries, to the dimensions necessary for this purpose. Automatic and semi-automatic cutting tables are state of the art for this, while the material to be cut must be stable and is gripped by means of clamping devices, transported into the cutting device, cut under pressure and subsequently transported further on.

However, separators may be brittle or at least very thin. This procedure is therefore impossible, without damaging the material. Moreover, cutting transversely to the transport direction does not permit the continuous transport of the material which, in the case of separators, is mostly in the form of sheet stock. Cutting transversely to the transport direction is designated at this juncture and hereafter by cutting to length. Hereafter, cutting is understood to mean the cutting of sheet stock in the transport direction, this being equivalent to the direction in which this sheet stock is rolled up.

The result of the cutting to length of layered and therefore multi-ply sheet stock is that the upper plies are displaced laterally and/or pinched by the knife which on a microscopic scale is wedge-shaped.

### DETAILED DESCRIPTION OF THE INVENTION

An object of the present invention, therefore, is to provide a method for cutting to length of sheet stock, which permits a continuous transport of the sheet stock, in particular can be integrated into a continuous roll-to-roll process, by means of which sheet stock, in particular battery separator stock, is nowadays usually produced and handled.

Thus, the present invention relates to a method for the cutting of abrasive sheet stock, that is to say material in which abrasive particles are located inside and/or on the surface of a carrier. The present invention relates particularly to a method for the cutting of ceramic separators or separators containing ceramic or oxidic constituents, the said separators being used, for example, in lithium-ion batteries.

The present invention provides a method for the cutting to length of sheet stock which has a carrier and abrasive particles, the abrasive particles being located inside and/or on at least part of the surface of the carrier, the method comprising
(a) provision of the sheet stock,
(b) cutting of the sheet stock to the required width, and, subsequently,
(c) winding of the sheet stock obtained according to step (b) onto a core or tube, and, subsequently,
(d) cutting to length of the sheet stock on the core or tube along the axis of the core or of the tube.

The method according to the present invention has the advantage that it can be integrated into the continuous production process for sheet stock of any type, in particular separators. The advantage of the method according to the present invention is also that a separate step, necessary for cutting to length, to fix the sheet stock becomes unnecessary, since the sheet stock is fixed automatically by being wound up.

A further subject of the present invention is the made-up stock (cut sheet stock) which is obtained by the method according to the present invention, and also the use of the stock according to the present invention as a separator in batteries.

The present invention is explained in more detail hereafter by way of example.

In step (c) of the method according to the present invention, preferably a core or a tube can be used, the diameter of which amounts to 100 to 10⁵ times the thickness of the sheet stock.

It may be advantageous, furthermore, in step (c) of the method according to the present invention, to use sheet stock having a thickness of 5 μm to 100 μm.

2 to 1000 plies of sheet stock can be wound onto the core or the tube in step (c), the number of plies being obtained from the rounded-off quotient of the difference between the largest diameter of the body, obtained according to step (c), perpendicularly to the body axis and the diameter of the core or of the tube and double the thickness of the sheet stock.

There is the possibility, in step (d) of the method according to the present invention, of using at least one fixed or rotating knife.

Preferably, in step (d), the sheet stock can be cut to length in a cut along the axis from outside in the direction of the axis of rotation of the body obtained according to step (c).

German patent application 10 2008 040894.8 filed Jul. 31, 2008, is incorporated herein by reference.

Numerous modifications and variations on the present invention are possible in light of the above teachings. It is therefore to be understood that within the scope of the appended claims, the invention may be practiced otherwise than as specifically described herein.

1. A method for the cutting to length of sheet stock, comprising:
(a) providing a sheet stock,
(b) cutting the sheet stock to a required width, and, subsequently,
(c) winding the sheet stock obtained in step (b) onto a core or tube, and, subsequently,
(d) cutting the sheet stock to length on the core or tube along the axis of the core or of the tube,
wherein the sheet stock has a carrier and abrasive particles,
wherein said abrasive particles are located inside and/or on at least part of the surface of the carrier.

2. The method according to claim 1, wherein, in step (c), a core or tube is used, the diameter of which amounts to 100 to 10⁵ times the thickness of the sheet stock.

3. The method according to claim 1, wherein, in step (c), sheet stock with a thickness of 5 μm to 100 μm is used.

4. The method according to claim 1, wherein, in step (c), from 2 to 1000 plies of sheet stock are wound onto the core or the tube, the number of plies being obtained from the rounded-off quotient of the difference between the largest diameter of the body, obtained according to step (c), perpendicularly to the body axis and the diameter of the core or tube and double the thickness of the sheet stock.

5. The method according to claim 1, wherein, in step (d), at least one fixed or rotating knife is used.

6. The method according to claim 1, wherein, in step (d), the sheet stock is cut to length in a cut along the axis from outside in the direction of the axis of rotation of the body obtained according to step (c).

7. A cut sheet stock, obtained by the method according to claim 1.

8. A battery, comprising:
the sheet stock according to claim 7 as a separator.

9. The battery as claimed in claim 8, which is a lithium ion battery.

10. The method according to claim 1, wherein said abrasive particles comprise a ceramic material.

11. The method according to claim 10, wherein said ceramic material is selected from the group consisting of Al₂O₃, SiO₂, BaTiO₃, ZrO₂, TiO₂ and mixtures thereof.

12. The method according to claim 10, wherein said ceramic material is selected from the group consisting of metal oxides and mixtures thereof.

13. The method according to claim 1, wherein said carrier comprises a polymer or mixtures of polymers.

14. The method according to claim 1, wherein said carrier comprises a polyolefin, a polyesters, a polyimide or mixtures thereof.

15. The method according to claim 1, wherein said carrier is porous.

16. The method according to claim 15, wherein said porous carrier is not an electrically conductive carrier.

17. The method according to claim 1, wherein said sheet stock comprises a polymer bonded web with a porous electrically insulating ceramic coating.

18. The battery according to claim 8, wherein said abrasive particles comprise a ceramic material.

19. The battery according to claim 18, wherein said ceramic material is selected from the group consisting of Al₂O₃, SiO₂, BaTiO₃, ZrO₂, TiO₂ and mixtures thereof.

20. The battery according to claim 8, wherein said carrier comprises a polymer or mixtures of polymers.
